(19) United States
(12) Patent Application Publication
(10) Pub. No.: US 2016/0303871 A1
(43) Pub. Date: Oct. 20, 2016

(54) CONVEYOR BELT FOR AN INKJET PRINT DEVICE

(71) Applicant: AGFA GRAPHICS NV, Mortsel (BE)

(72) Inventor: Luc BOUWENS, Mortsel (BE)

(21) Appl. No.: 15/102,899

(22) PCT Filed: Jan. 15, 2015
(86) PCT No.: PCT/EP2015/050707

§ 371 Date: Jun. 9, 2016

(30) Foreign Application Priority Data
Jan. 21, 2014 (EP) 14151898.5

(51) Int. Cl. B41J 11/00; B41J 2/01; B41J 2/005

(52) U.S. Cl. CPC B41J 11/007; B41J 2/0057; B41J 2/01; B41J 2002/012

(57) ABSTRACT

A method using an inkjet print device for printing on a substrate includes a conveyor belt system, wherein the conveyor belt system includes a conveyor belt with synthetic setae to transport the substrate and to hold the substrate while printing on the substrate.

### CROSS-REFERENCE TO RELATED APPLICATIONS

This application is a 371 National Stage Application of PCT/EP2015/050707, filed Jan. 15, 2015. This application claims the benefit of European Application No. 14151898.5, filed Jan. 21, 2014, which is incorporated by reference herein in its entirety.

### BACKGROUND OF THE INVENTION

1. Field of the Invention

The invention relates to the transport of a substrate, for example a paper sheet, in an inkjet printer, wherein the inkjet printer comprises a conveyor system such as a conveyor belt system. The substrate is transported by the conveyor system while printing on the substrate.

2. Description of the Related Art

To connect a substrate on a conveyor belt while printing on the substrate, several methods and systems are known in the state of the art.

The most used system is a vacuum chamber underneath the conveyor belt wherein the conveyor belt is porous and the substrate is attached to the conveyor belt by a vacuum power.

An example of vacuum chamber for a print device such as an inkjet printer is disclosed in US20100213666 (XEROX CORPORATION) wherein the vacuum chamber is located underneath a conveyor belt that that varies the vacuum zones in size and position on the conveyor belt and wherein a movable wall, as movable vacuum divider, is disclosed to adjust the vacuum zones based on the width of the substrate.

The vacuum force to hold down and to connect the substrate to the conveyor belt can be significantly high and large pumps are needed for this purpose. The vacuum table above the vacuum chamber needs air channels which cause image artefacts and substrate deformation. Also the conveyor belt will be pulled to the vacuum table by the vacuum force which requires stronger forces to drive the conveyor belt with additional problems such as slip.

The handling of multiple substrates at the same on the conveyor belt by multiple sub vacuum chambers is using techniques with multiple pumps in cascade to increase force or is using complex mechanical sliders in the vacuum chamber to adjust of the vacuum zones on the vacuum table above the vacuum chamber and is using a matrix array of valves to control the vacuum zones on the vacuum chamber above the vacuum chamber.

An example of a digital printer wherein a vacuum chamber is using movable partitions in a vacuum chamber is disclosed in DE102010049258 (WEMHOENER SURFACE GMBH).

Depending on the air permeability of the substrate the vacuum force need to be controlled to connect the substrate on the conveyor belt with enough force to hold down the substrate while printing.

In a production environment while using an inkjet print device, that is capable of creating vacuum zones, contaminations such as paper dust, substrate fibers, ink, ink residues and/or ink debris such as cured ink, contaminate the inner surface of the air channels in the vacuum table and the inner surface of the vacuum chamber and thus also if applicable a movable vacuum divider inside the vacuum chamber. These contaminations need to be cleanable in the vacuum chamber itself without creating vacuum leakages else uncontrolled movement of the movable vacuum divider may occur due to obstacles of the contaminations. However the cleaning results in a significant downtime for the inkjet print device.

Another system to connect a substrate on a conveyor belt is the use of a sticky conveyor belt. Using a sticky conveyor belt allows an exact positioning of the substrate on the sticky conveyor belt. And the substrate, especially flexible woven substrate, shall not be stretched and/or deformed while the substrate is being printed. The adhesive on the top layer of the sticky conveyor belt may be activated by an infrared drier to make the conveyor belt sticky or the top layer comprises a removable pressure sensitive adhesive.

An example of a sticky conveyor belt is disclosed in WO2002038855 (APRION DIGITAL LTD) wherein a method for printing on a dimensionally-unstable substrate (14), such as textile is provided.

Sticky conveyor belts uses adhesive, such as glue, which contaminates the substrate and the conveyor belt which limits the life time of the conveyor belt.

In a production environment while using an inkjet print device, with a sticky conveyor belt, contaminations such as paper dust, substrate fibers, ink, ink residues and/or ink debris such as cured ink, contaminate the sticky conveyor belt which results in lower adhesion of the substrates on the sticky conveyor belt.

To disconnect the substrate from the sticky conveyor belt, the substrate must be pulled off the adhesive surface of the sticky conveyor belt with force.

In an inkjet print device different types of substrates needs to be printed wherein the adhesion capabilities of the sticky conveyor belt needs to be adapted which results in the use of different adhesives on the sticky conveyor belt.

So there is still a need to provide a belt conveyor system in an inkjet printer device to transport substrate by minimal force, with accurate positioning capability and to handle different types and sizes of substrates, eventual handle multiple substrates at the same time, and this without changing the print capabilities of the top layer of the substrate.

### SUMMARY OF THE INVENTION

In order to overcome the problems described above, preferred embodiments of the present invention have been realised with an inkjet printing method as defined below, wherein the inkjet printing method is performed by an inkjet print device.

The inkjet print device comprises a conveyor system to transport the substrate; and wherein the conveyor system comprises a fibrillar adhesive system, such as synthetic setae, to hold a substrate stable while printing on the substrate. “Stable” means to be fixed and not moveable while printing. Holding the substrate stable while printing on the substrate is necessary e.g. to avoid misalignment or color shifts in the printed pattern on the substrate. The fibrillar adhesive system, such as synthetic setae which are emulations of setae found on the toes of geckos.

The fibrillar adhesive system may also be emulations of adhesive systems of the toes of a beetle, fly, spider or gecko. But the emulations of setae found on the toes of geckos are most preferred for their adhesion capabilities.

The fibrillar adhesive system, such as synthetic setae, comprised in the conveyor system are designed to apply the best fit holding force and it does not use any moving parts for adjusting the holding field such as the use of pumps and they don't influence the force of the transporting the substrate. Preferably the synthetic setae are arranged in lamellae wherein the lamellae are oriented across the transport direction of the conveyor belt. The orientation of the synthetic setae gives a better stability of the substrate while transporting.

Synthetic setae are self-cleaning because the repeated connection and disconnection of the synthetic setae with a substrate the conveyor system remains clean from contaminations such as paper dust, substrate fibers, ink debris such as cured ink.

In a preferred embodiment the conveyor system comprises a plurality of pulleys whereon a web, such as a web of flexible woven material, is transported in a transport direction and wherein the top layer of one of the pulleys comprises synthetic setae for the stability of the web while printing and transporting of the web. Two or more of the plurality of the pulleys are controlling the web tension of the web while printing on the web. The synthetic setae on the pulley are in this preferred embodiment designed to connect the web to hold the web stable when the transporting is stopped and designed to disconnect from the web when the web transported in the transport direction and the force of the drive system of the conveying system is higher than the adhesion forces of the synthetic setae and the web. Preferably the synthetic setae are arranged in lamellae wherein the lamellae are oriented across the transport direction of the web. This orientation of the synthetic setae gives a better design to disconnect from the web when the web transported in the transport direction and the force of the drive system of the conveying system is higher than the adhesion forces of the synthetic setae and the web.

The drive system of a preferred embodiment may be driven by an electric motor to produce a torque to one of the pulleys so by friction of the web on the powered pulley the web is moved in the transport direction. The electric motor is preferably an electric stepper motor. The drive system may comprise an encoder system wherein the encoder system measures the linear feed of the web directly on the web by a measuring device comprising a position sensor that may attachable to the web and a stationary reference means wherein the relative position of the position sensor to the stationary reference means is detected. The powered pulley is preferably the pulley with the synthetic setae.

Another drive system of a preferred embodiment may comprise:
a driving means to drive and control a first linear movement system;
a first belt gripper that has a first engaging means to engage the web when the first belt gripper is moved by the first linear movement system from a home position to an end position and that has a first releasing means to release the web when the first belt gripper is moved by the first linear movement system from the end position to the home position;
a second belt gripper that has a second releasing means to release the web when the first belt gripper is moved by the first linear movement system from the home position to the end position and that has a second engaging means to engage the web when the first belt gripper is moved by the first linear movement system from the end position to the home position. An encoder system may be mounted on the linear movement system, so the position of the moving belt gripper and distance of the successive distance movements of a substrate on the conveyor belt can be communicated.

The advantageous effect of this latest preferred drive system of linear movement system is that no slip occurs contrary to the conveyor system driven by a stepper motor to power a pulley.

A preferred inkjet print device may have a first set of synthetic setae that are grouped in a first attaching zone on the top layer of the pulley with the synthetic setae and may have preferably a second set of synthetic setae that are grouped in a second attaching zone on the top layer of the pulley with the synthetic setae.

The attaching zones are preferably positioned on the edges of the top layer of the pulley with the synthetic setae to have a better stability of the web across the web.

In another preferred embodiment the conveyor system is a conveyor belt system with a conveyor belt wrapped around a inlet pulley and outlet pulley and wherein the step of connecting the substrate to the conveyor belt step is characterized by connecting the substrate on the top layer of the conveyor belt by synthetic setae which are comprised on the top layer of the conveyor belt. The inlet pulley is the pulley where the substrate entrances the conveyor belt of this preferred inkjet print device and the outlet pulley is the pulley where the substrate exits the substrate from the conveyor belt of this preferred inkjet print device.

The printing method by this preferred embodiment of the inkjet print device may connect the substrate to the top layer when the conveyor belt, underneath the substrate, rotates around the inlet pulley. The synthetic syntae may be constructed so that holding force depends on the bending of the conveyor belt. Preferably the synthetic setae are arranged in lamellae wherein the lamellae are oriented across the transport direction of the conveyor belt. This orientation of the synthetic setae gives a better design to make the synthetic syntae depending on the bending of the conveyor belt such as around a pulley.

Also the printing method by this preferred inkjet print device on a substrate may disconnect from the top layer when the conveyor belt, underneath the substrate, rotates around the outlet pulley. The synthetic syntae may be constructed so that holding force depends on the bending of the conveyor belt.

An advantage of the synthetic syntae on the conveyor belt is that the holding force by the synthetic syntae doesn't influence the friction or slip of the conveyor belt system such as the known holding systems, such as a vacuum chamber or sticky conveyor belt systems.

The packing density of the synthetic setae on the conveyor belt may be between 100 and 1000 synthetic setae per square millimetre, more preferably between 400 and 2000 synthetic setae per square millimetre, and most preferably at least 400 synthetic setae per square millimetre.

A preferred embodiment of the inkjet print device with the conveyor belt may comprise a first set of synthetic setae are grouped in a first attaching zone on the top layer of the conveyor belt and more preferably may comprise a second set of synthetic setae grouped in an second attaching zone.

The packing density of the synthetic setae in the first and/or second attaching zone may be between 100 and 1000 synthetic setae per square millimetre, more preferably between 400 and 2000 synthetic setae per square millimetre, and most preferably at least 400 synthetic setae per square millimetre.

A preferred embodiment of the inkjet print device with the conveyor belt may comprise also synthetic setae at the bottom layer of the conveyor belt to stabilize the conveying path of the conveyor belt. A first set of synthetic setae may be grouped in a first attaching zone on the bottom layer of the conveyor belt and may have preferably a second set of synthetic setae that are grouped in a second attaching zone on the bottom layer of the pulley with the synthetic setae. The attaching zones on the bottom layer are preferably positioned on the edges of the conveyor belt to create a better stability of the web across the web and corrector path of the conveyor belt in the inkjet print device.

The drive system of a preferred embodiment of the inkjet print device with the conveyor belt may be driven by an electric stepper motor to produce a torque to one of the pulleys so by friction of the conveyor belt on the powered pulley the conveyor belt is moved in the transport direction. The drive system may comprise an encoder system wherein the encoder system measures the linear feed of the conveyor belt directly on the conveyor belt by a measuring device comprising a position sensor that may attachable to the conveyor belt and a stationary reference means wherein the relative position of the position sensor to the stationary reference means is detected.

Another drive system of a preferred embodiment of the inkjet print device with the conveyor belt may comprise:
a driving means to drive and control a first linear movement system;
a first belt gripper that has a first engaging means to engage the conveyor belt when the first belt gripper is moved by the first linear movement system from a home position to an end position and that has a first releasing means to release the conveyor belt when the first belt gripper is moved by the first linear movement system from the end position to the home position;
a second belt gripper that has a second releasing means to release the conveyor belt when the first belt gripper is moved by the first linear movement system from the home position to the end position and that has a second engaging means to engage the conveyor belt when the first belt gripper is moved by the first linear movement system from the end position to the home position.

An encoder system may be mounted on the linear movement system, so the position of the moving belt gripper and distance of the successive distance movements of a substrate on the conveyor belt can be communicated.

The advantageous effect of this latest preferred drive system of linear movement system is that no slip occurs contrary to the conveyor system driven by an electric motor to power a pulley.

In a preferred embodiment the conveyor system comprises a drum, also called a print-cylinder, whereon a sheet is transported and the drum is rotating while printing on the sheet and/or previous printed layers and wherein the drum its top surface, which is in contact with the sheet, comprises a fibrillar adhesive system, such as synthetic setae. The fibrillar adhesive system, such as synthetic setae, in this preferred embodiment are designed to connect the sheet to hold the web stable when the transporting is stopped and to hold down the sheet while rotating with the drum for example while printing. These synthetic setae are also designed to disconnect from the web when the sheet is released in the transport direction to the output of the printer and the force of the release system of the conveying system is higher than the adhesion forces of the synthetic setae and the sheet. Preferably the synthetic setae are arranged in lamellae wherein the lamellae are oriented across the transport direction of the sheet. This orientation of the synthetic setae gives a better design to disconnect from the sheet when the sheet is released in the transport direction and the force of the release system of the conveying system is higher than the adhesion forces of the synthetic setae and the sheet. The sheet in this preferred embodiment is preferably a lithographic support and the inkjet print device an inkjet CTP device. An advantage of inkjet CTP is that no chemical processing, such as developing, is needed to prepare a printing plate. An example of an inkjet CTP method is disclosed in EP 05736134 A (GLUNZ).

The preferred embodiments in the current invention are not only restricted to synthetic setae but the synthetic setae may also be a fibrillar adhesive system. Synthetic setae of Geckskin™ by FelsumaLLC for apparel and household hanging is a preferred product to attach a fibrillar adhesive system to the conveyor system of the present invention.

### BRIEF DESCRIPTION OF THE DRAWINGS

FIG. 1 is an illustration of a preferred embodiment wherein substrates (4) are transported underneath an inkjet print head (6) by a conveyor belt (1) in the transport direction (5) to print a mark. The conveyor belt (1) is wrapped around an inlet pulley (2) and an outlet pulley (3). The outlet pulley (3) is powered with a electric motor to rotate and to move the conveyor belt in the transport direction (5). The conveyor belt comprises synthetic setae to transport in a stable manner the substrates.

FIG. 2 is an illustration of another preferred embodiment similar as in FIG. 1 but wherein the printed mark on the substrates is cured by a drying system (7).

FIG. 3 is an illustration of a preferred embodiment wherein the substrate (4) is a web supported by an inlet pulley (2) and outlet pulley (3) and wherein the substrate is transported in the transport direction (5). An inkjet print head print a mark on the substrate. The outlet pulley (3) is powered with a electric motor to rotate and to move the conveyor belt in the transport direction (5). The outlet pulley comprises synthetic setae to transport in a stable manner the web. The web is only visible as part between the two pulleys.

FIG. 4 is an illustration of another preferred embodiment similar as in FIG. 1 but wherein the printed mark on the substrates is printed by two inkjet print heads wherein the inks of both inkjet print heads is different.

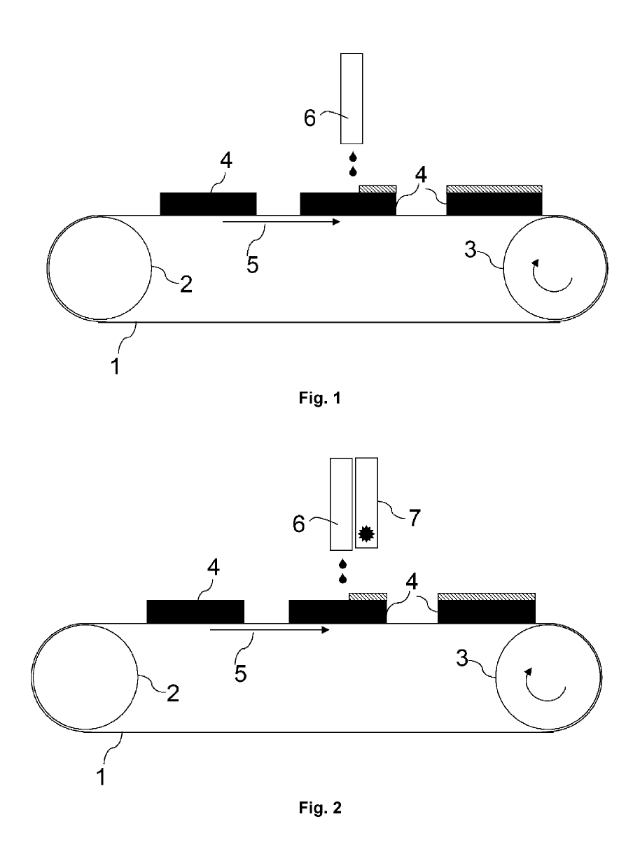

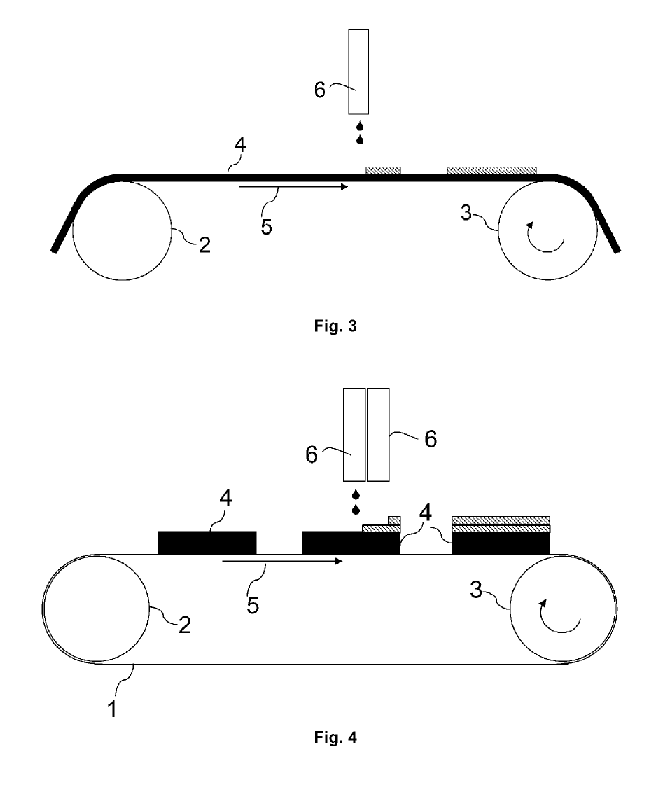

### DETAILED DESCRIPTION OF THE PREFERRED EMBODIMENTS

### Geckos

Geckos are lizards belonging to the infraorder Gekkota, found in warm climates throughout the world. For example the Uroplatus Fimbriatus, with as common name leaf-tailed gecko, is found in eastern Madagascar. The 5-toed feet of a gecko are covered with elastic hairs, also called setae, and the end of these hairs are split into nanoscale structures called spatulae (because of their resemblance to actual spatulas). The toes of a gecko have a special adaptation that allows them to adhere to most surfaces without the use of liquids or surface tension. The spatula-shaped setae arranged in lamellae on gecko footpads of toes enable attractive van der Waals' forces, wherein no fluids are involved, between the β-keratin structures and the surface.

### The Conveyor Belt

The conveyor belt is made of at least one material such as a metal belt. But it needs not be porous as in a conveyor system with a vacuum chamber which makes the choice of materials easier and the cost of the conveyor belt cheaper. Preferably the conveyor belt includes magnetically attractable material such as a metal conveyor belt and/or the conveyor belt has one layer of a woven fabric web. More preferably the conveyor belt has two or more layers of materials wherein an under layer provides linear strength and shape, also called the carcass and an upper layer called the cover or the support side. The carcass is preferably a woven fabric web and more preferably a woven fabric web of polyester, nylon or cotton. The material of the cover is preferably various rubber and more preferably plastic compounds and most preferably thermoplastic. But also other exotic materials for the cover can be used such as silicone or gum rubber when traction is essential. Preferably one of the engage-zones on the conveyor belt for the belt grippers has less layers and/or thinner layer(s) than in one of the carry-zones to have a faster and better grip. An example of a multi-layered conveyor belt for a general belt conveyor system wherein the cover having a gel coating is disclosed in US 20090098385 A1 (FORBO SIEBLING GMBH).

Preferably the conveyor belt is a glass fabric or the carcass is glass fabric and more preferably the glass fabric has a coated layer on top with a thermoplastic polymer and most preferably the glass fabric has a coated layer on top with polytetrafluoroethylene also called PTFE.

If a gripper that may be attached to the conveyor belt is applicable in one of the preferred embodiments, preferably at the zone wherein the gripper is attaching the conveyor belt by a gripper has less layers and/or thinner layer(s) to have a faster and better grip of the conveyor belt.

Preferably the conveyor belt is and endless conveyor belt. Examples and figures for manufacturing an endless multi-layered conveyor belt for a general belt conveyor system are disclosed in EP 1669635 B (FORBO SIEBLING GMBH).

### Synthetic Setae

Synthetic setae are a simulation of the structure of the setae of a gecko in synthetic material. A group of synthetic setae on a material with a package density of more than 100 synthetic setae per square millimetre is also called gecko tape.

The synthetic setae in a preferred embodiment of the inkjet print device may be preferably manufactured on the conveying system by photolithography, electron beam lithography, plasma etching, reactive ion etching, chemical vapour deposition or micro-moulding. But most preferably the synthetic setae are manufactured by photolithography and most preferably the synthetic setae are manufactured by electron beam lithography wherein a beam of electrons create nanoscale patterns on a surface of the conveying system such as a pulley in one of the preferred embodiments or a conveyor belt in other preferred embodiments.

In a preferred embodiment with the conveyor belt one or more gecko tapes may be attached to the conveyor belt wherein each gecko tape defines than an attaching zone on the conveyor belt and in a preferred embodiment of the pulley with synthetic setae one or more small gecko tapes may be attached to this pulley. These gecko tapes attached to the conveyor belt or the pulley with synthetic setae are manufactured by photolithography, electron beam lithography, plasma etching, reactive ion etching, chemical vapour deposition or micro-moulding.

In a preferred embodiment of the inkjet print device the synthetic setae comprise polymer and more preferably comprise polyimide, polypropylene or polydimethylsiloxane and most preferably carbon nanotubes. Carbon nanotubes are allotropes of carbon with a cylindrical nanostructure and are preferred to be comprised in the synthetic setae of a preferred embodiment because carbon nanotubes are the strongest and stiffest materials yet discovered in terms of tensile strength and elastic modulus respectively.

The average diameter of the synthetic setae is preferably between 1 and 100 μm, more preferably between 1 and 50 μm and most preferably between 1 and 25 μm. The average height-to-diameter ratio of the synthetic setae is preferably greater than 3.

The design of the synthetic setae to improve the connection of the substrate to the conveyor belt in a preferred embodiment with the conveyor belt and to improve the connection of the substrate to the pulley in a preferred embodiment with the web is especially checked on the following parameters of the synthetic setae for cantilever beam principles:
length, radius and angle of the shaft of the synthetic setae; and
the package density of the synthetic setae in the gecko tape; and on the following parameters of the synthetic setae for material independence stickiness:
spatulae size; and
the package density of the spatulae on a synthetic setae.

### Inkjet Print Device

An inkjet print device comprises an inkjet print head to print a liquid, such as an ink, on the substrate. There are several types of inkjet print heads. The inkjet print device of a preferred embodiment may comprise inkjet print head capable of using continuos inkjet, piezo DOD inkjet, thermal inkjet, hertz continuos mist inkjet, electrostatic drop-on-demand (EIJ), liquid fault tolerant printing (LIFT), magnetic inkjet (MIJ) or acousting ink printing (AIP) technology.

A preferred print head for the inkjet print device in a preferred embodiment is a so-called valve jet print head. Preferred valve jet print heads have a nozzle diameter between 45 and 600 μm. This allows for a resolution of 15 to 150 dpi which is preferred for having high productivity while not comprising quality.

In a preferred embodiment, the resolution of the valve jet print head is 15 to 150 dpi, preferably the resolution is no more than 75 dpi, more preferably no more than 50 dpi for maximizing printing speed and productivity. The valve jet print head preferably jets droplets of 1 to 1500 nanoliter, which is much more than the picoliter droplets used jetted most piezoelectric or thermal inkjet print devices.

The way to incorporate valve jet print heads into the print equipment is well-known to the skilled person. For example, US 2012105522 (MATTHEWS RESOURCES INC) discloses a valve jet printer including a solenoid coil and a plunger rod having a magnetically susceptible shank.

Suitable commercial valve jet print heads are chromoJET™ 200, 400 and 800 from Zimmer and Printos™ P16 from VideoJet.

Another preferred inkjet print head is a through flow inkjet print head wherein the pigment particles in the inkjet ink permit free flow of the ink through the inkjet printing device, especially at the ejecting nozzles to prevent sedimentation of pigment particles in the inkjet print head.

More information about inkjet print devices is disclosed in STEPHEN F. POND. Inkjet technology and Product development strategies. United States of America: Torrey Pines Research, 2000. ISBN 0970086008.

Preferably the inkjet print device is multi-pass inkjet print device, such as a wide format inkjet print device and more preferably a single pass inkjet print device by e.g. a page-wide inkjet print head array wherein the substrate is passed by a inkjet print head is only once. The page-wide inkjet print head array may be constructed monolithically.

In a multi-pass inkjet print device, the inkjet print head normally scans back and forth in a transversal direction across the moving substrate. In a multi-pass printing method shingling and interlacing methods may be used as exemplified by EP 1914668 (AGFA-GEVAERT) or print masks method may be used as exemplified by U.S. Pat. No. 7,452,046 (HEWLETT-PACKARD)

Preferably the inkjet print device is a roll-to-roll device with a rotary substrate in-feed and rotary substrate out-feed and more preferably a roll-to-sheet device which comprises a rotary substrate in-feed and a substrate cutter to separate the rotary substrate in sheets.

A pattern that is printed on the surface of a substrate is preferably an image. The surface of the substrate may already be marked by a marking device, such as inkjet print device. The pattern may have an achromatic or chromatic colour. To enhance the adhesion of the pattern on the substrate the inkjet print device may comprise a drying system, such as an UV source, to dry the marked pattern on the substrate to have a better adhesion. Most preferably the inkjet print device with one or more inkjet print heads jets an UV curable ink to mark the surface of the substrate. The synthetic setae may than not influenced by the drying system.

Spreading of a UV curable inkjet ink on a substrate can further be controlled by a partial curing or “pin curing” treatment wherein the ink droplet is “pinned”, i.e. immobilized and no further spreading occurs. For example, WO 2004/002746 (INCA) discloses an inkjet printing method of printing an area of a substrate in a plurality of passes using curable ink, the method comprising depositing a first pass of ink on the area; partially curing ink deposited in the first pass; depositing a second pass of ink on the area; and fully curing the ink on the area.

A preferred configuration of UV source (44) is a mercury vapour lamp. Within a quartz glass tube containing e.g. charged mercury, energy is added, and the mercury is vaporized and ionized. As a result of the vaporization and ionization, the high-energy free-for-all of mercury atoms, ions, and free electrons results in excited states of many of the mercury atoms and ions. As they settle back down to their ground state, radiation is emitted. By controlling the pressure that exists in the lamp, the wavelength of the radiation that is emitted can be somewhat accurately controlled, the goal being of course to ensure that much of the radiation that is emitted falls in the ultraviolet portion of the spectrum, and at wavelengths that will be effective for UV curable ink curing. Another preferred UV source (44) is an UV-Light Emitting Diode.

### Substrate

The substrate can be any material. The substrate can be one or a plurality of regular or irregular shaped objects, large or small objects, light or heavy objects. Preferably the substrate in a preferred embodiment is a flat workpiece and more preferably flexible sheets (e.g. paper, transparency foils, adhesive PVC sheets or ink-receivers) with thickness down to 100 micrometers and preferably down to 50 micrometers. Most preferably rigid sheets (e.g. hard board, PVC, carton, wood or ink-receivers) are used preferably with a thickness up to 2 centimetres and more preferably up to 5 centimetres. More preferably the substrate is flexible web material (e.g. paper, adhesive vinyl, fabrics and PVC, textile), also called a web.

A preferred embodiment of the inkjet print device is wherein the inkjet print device is a single pass inkjet print device and wherein the substrate is a web and wherein the configuration of the single pass inkjet print device is a roll-to-roll print device and more preferably a roll-to-sheet print device.

Before the substrate is transported by the conveyor belt to move in a conveying direction, also called transport direction, by the drive system, the substrate may have been carried and/or transported by another transportation means such as a feeder or other conveyor system. After the substrate is carried by the conveyor belt to move in the conveying direction by the drive system, the substrate may be carried and/or transported by another transportation means such as a stacker or other conveyor system.

The transportation of the substrate by the conveying system in a preferred embodiment of the inkjet print device may transport the substrate in successive movements wherein between the successive movements the substrate is printed by the inkjet print device. Preferably in a multi pass inkjet print device such successive movements are performed between each pass.

A preferred embodiment of the inkjet print device is wherein the inkjet print device is a textile inkjet print device and wherein the substrate is a flexible woven material and more preferably web of flexible woven material.

The inkjet print device may be an UV inkjet print device which jets UV curable ink on the substrate.

In another preferred embodiment the substrate may be comprising glass, stone, metallic or ceramic material.

### Attaching Zones

An attaching zone is a zone in the conveyor system of a preferred embodiment wherein a substrate may be connected to the conveyor system and comprises the synthetic setae. The attaching zone in a preferred embodiment may have an area from 0.25 mm² until 1 cm² and more preferably from 0.25 mm² until 100 cm² and most preferably from 1 mm² until 200 cm². The attaching zone may be a virtual band along the conveyor belt or a virtual band along the pulley which comprises the synthetic setae in a preferred embodiment. A preferred embodiment may have one or more attaching zones in the conveyor system. When more than one substrate is connected to the conveyor system, each substrate may be connected via another attaching zone, so a plurality of substrates may be printed at the same time when transported in the transport direction.

Preferably the ratio between the total area of the attaching zones on the conveyor belt and the area of the top surface of the conveyor belt is between 1% and 100%, more preferably between 5% and 100% and most preferably between 30% and 100%.

Preferably the ratio between the total area of the attaching zones on the pulley with the synthetic setae and the area of the top surface of the pulley with the synthetic setae is between 1% and 100%, more preferably between 5% and 100% and most preferably between 30% and 100%.

The attaching zone may be at the edge of the conveyor belt or the edge of the pulley with the synthetic setae. More preferably a preferred embodiment may comprise two attaching zones, one at each edge of the conveyor belt or the pulley with the synthetic setae and most preferably a preferred embodiment may comprise an attaching zone in the middle between the edges of the conveyor belt or the pulley with the synthetic setae.

### Inkjet CTP Systems

Inkjet CTP systems is a marking device that is using a printhead such as valve-jet printhead, an inkjet printhead, an piezo-electric printhead, page-wide inkjet arrays or an inkjet printing head assembly with one or more inkjet printheads to jet a liquid to form printing areas of the lithographic image to prepare a lithographic printing plate comprising the lithographic image.

The inkjet CTP system may be a flat bed printing system wherein the lithographic support is positioned horizontal (=parallel to the ground) or vertical on a flat printing support in the inkjet CTP system (FIG. 6) or the inkjet CTP system may be a drum based inkjet print device wherein the lithographic support is wrapped around a cylindrical printing support in the inkjet CTP system (FIG. 5).

If the inkjet CTP system is a drum based inkjet print device, the linear velocity of the printhead in the direction Y (=along the cylindric printing support) may be locked with the rotational speed X of the cylindrical printing support, so each nozzle of the printhead jets fluid along a spiral path on the lithographic support which is wrapped around the cylindrical printing support.

The printhead in an inkjet CTP system may scan back and forth in a transversal direction across the moving of the lithographic supports. This method is also called multi pass inkjet printing. In a multi-pass printing method shingling and interlacing methods may be used as exemplified by EP 1914668 (AGFA-GEVAERT) or print mask methods may be used as exemplified by U.S. Pat. No. 7,452,046 (HEWLETT-PACKARD). The print mask in a print masks method is preferably a pseudo-random distribution mask and more preferably a pseudo-random distribution with blue-noise characteristics.

In a preferred method the jetting of the liquid is performed by single pass inkjet printing, which can be performed by using page wide printhead, such as a page wide inkjet printhead or multiple staggered inkjet printheads which cover the total width of the lithographic supports. In a single pass inkjet printing method the inkjet printheads usually remain stationary and the lithographic supports are transported once under the page wide printhead. An advantage of single pass inkjet printing is the fastness of preparation of the lithographic printing plates and a better dot placement of the jetted droplets which give a better alignment.

The inkjet CTP may comprise a two-dimensional inkjet printing method but may also comprise a three-dimensional inkjet printing method for the manufacturing of relief printing plates, also called relief printing master, such as disclosed in US20130141488 (AGFA GRAPHICS)

The print quality of the inkjet CTP system depends on the addressability, also called print resolution, of the system. It is in literature given as “dots per inch” or dpi. The printing pitch is the smallest distance, between to neighbour addresses, also called pixels, on which the inkjet CTP system jets its liquid. An address in an inkjet CTP system corresponds to a pixel in the raster image.

In a preferred embodiment the inkjet CTP system has a printing pitch between 1200 dots per inch (DPI) and 9600 dots per inch (DPI).

### Lithographic Support

The support of the lithographic printing plate has a hydrophilic surface or is provided with a hydrophilic layer. It is also called a lithographic or hydrophilic support. Such a lithographic support has a rectangular shape.

In a preferred embodiment of the invention the lithographic support is a grained and anodized aluminium support.

By graining and/or roughening the aluminium support, both the adhesion of the printing areas and the wetting characteristics of the non-printing areas are improved. By varying the type and/or concentration of the electrolyte and the applied voltage used in the graining step, different type of grains can be obtained. The surface roughness is often expressed as arithmetical mean center-line roughness Ra (ISO 4287/1 or DIN 4762) and may vary between 0.05 and 1.5 μm. The aluminium substrate of the current invention has preferably an Ra value between 0.30 and 0.60 μm, more preferably between 0.35 and 0.55 μm and most preferably between 0.40 and 0.50 μm. The lower limit of the Ra value is preferably 0.1 μm. More details concerning the preferred Ra values of the surface of the grained and anodized aluminium support are described in EP-A 1356926.

By anodizing the aluminium support, its abrasion resistance and hydrophilic nature are improved. The microstructure as well as the thickness of the Al₂O₃ layer is determined by the anodizing step. The anodic weight (g/m² Al₂O₃ formed on the aluminium surface) varies between 1.0 and 8.0 g/m². The anodic weight is preferably between 1.5 g/m² and 5.0 g/m², more preferably between 2.5 g/m² and 4.0 g/m² and most preferably between 2.5 g/m² and 3.5 g/m².

The grained and anodized aluminium support may be subjected to a so-called post-anodic treatment to further improve the hydrophilic character of its surface. For example, the aluminium support may be silicated by treating its surface with a solution including one or more alkali metal silicate compound(s)—such as for example a solution including an alkali metal phosphosilicate, orthosilicate, metasilicate, hydrosilicate, polysilicate or pyrosilicate—at elevated temperatures, for example at 95° C. Alternatively, a phosphate treatment may be applied which involves treating the aluminium oxide surface with a phosphate solution that may further contain an inorganic fluoride. Further, the aluminium oxide surface may be rinsed with a citric acid or citrate solution, gluconic acid, or tartaric acid. This treatment may be carried out at room temperature or may be carried out at a slightly elevated temperature of about 30 to 50° C. A further interesting treatment involves rinsing the aluminium oxide surface with a bicarbonate solution. Still further, the aluminium oxide surface may be treated with polyvinylphosphonic acid, polyvinylmethylphosphonic acid, phosphoric acid esters of polyvinyl alcohol, polyvinylsulphonic acid, polyvinylbenzenesulphonic acid, sulphuric acid esters of polyvinyl alcohol, acetals of polyvinyl alcohols formed by reaction with a sulphonated aliphatic aldehyde, polyacrylic acid or derivates such as GLASCOL E15™ commercially available from Ciba Speciality Chemicals. One or more of these post treatments may be carried out alone or in combination. More detailed descriptions of these treatments are given in GB-A 1084070, DE-A 4423140, DE-A 4417907, EP-A 659909, EP-A 537633, DE-A 4001466, EP-A 292801, EP-A 291760 and U.S. Pat. No. 4,458,005.

In a preferred embodiment, the support is first treated with an aqueous solution including one or more silicate compound(s) as described above followed by a treatment of the support with an aqueous solution including a compound having a carboxylic acid group and/or a phosphonic acid group, or their salts. Particularly preferred silicate compounds are sodium or potassium orthosilicate and sodium or potassium metasilicate. Suitable examples of a compound with a carboxylic acid group and/or a phosphonic acid group and/or an ester or a salt thereof are polymers such as polyvinylphosphonic acid, polyvinylmethylphosphonic acid, phosphoric acid esters of polyvinyl alcohol, polyacrylic acid, polymethacrylic acid and a copolymer of acrylic acid and vinylphosphonic acid. A solution comprising polyvinylphosphonic acid or poly(meth)acrylic acid is highly preferred.

The lithographic support may also be a flexible support, which may be provided with a hydrophilic layer. The flexible support is e.g. paper, plastic film or aluminium. Preferred examples of plastic film are polyethylene terephthalate film, polyethylene naphthalate film, cellulose acetate film, polystyrene film, polycarbonate film. The plastic film support may be opaque or transparent.

The hydrophilic layer is preferably a cross-linked hydrophilic layer obtained from a hydrophilic binder cross-linked with a hardening agent such as formaldehyde, glyoxal, polyisocyanate or a hydrolyzed tetra-alkylorthosilicate. The latter is particularly preferred. The thickness of the hydrophilic layer may vary in the range of 0.2 to 25.0 μm and is preferably 1.0 to 10.0 μm. More details of preferred embodiments of the base layer can be found in e.g. EP-A 1 025 992.

The hydrophilic surface of the support is preferably provided with a surfactant to improve the resolution of the printing plate obtained by the method of the present invention. A higher resolution may be obtained when the spreading of the droplets of the first curable fluid on the hydrophilic surface is minimized. Preferred surfactants are fluorosurfactants, for example the Zonyl® surfactants from Dupont. Also preferred are the more environmently friendly Tivida® fluorosurfactants from Merck.

The amount of fluorosurfactants on the support surface is preferably between 0.005 and 0.5 g/m², more preferably between 0.01 and 0.1 g/m², most preferably between 0.02 and 0.06 g/m².

A particular preferred lithographic support is a grained and anodized aluminium support as described above, treated with an aqueous solution including one or more silicate compound(s), and of which the surface is provided with a fluorosurfactant.

### Other Preferred Embodiment

The inkjet print device may have a conveyor belt to transfer ink to a substrate prior the ink is jetted on the conveyor belt, which is also called the transfer belt. The transfer belt may comprise synthetic setae to improve the stability of the ink layers by connection on the transfer belt while transporting and wherein the synthetic setae are releasing from the transfer belt the ink layers while transfer the ink layers on the substrate.

The inkjet print device may also be used to create objects on the conveyor belt through a sequential layering process, also called additive manufacturing or 3D printing. The objects that are manufactured additively can be used anywhere throughout the product life cycle, from pre-production (i.e. rapid prototyping) to full-scale production (i.e. rapid manufacturing), in addition to tooling applications and post-production customization.

### INDUSTRIAL APPLICABILITY

The invention of an inkjet print device with conveyor system comprising synthetic setae improves the quality of inkjet printed samples on substrates, economically gives lower manufacturing cost for such inkjet printer and easier maintenance of such inkjet printer by an operator in a production environment.

### REFERENCE SIGNS LIST

1 conveyor belt
2 inlet pulley
3 outlet pulley
4 substrate
5 transport direction
6 inkjet print head
7 drying system

1-10. (canceled)

11. A method of printing with an inkjet printer comprising:
providing the inkjet printer with a conveyor including a fibrillar adhesive system; and
connecting a substrate to the conveyor using the fibrillar adhesive system to hold the substrate stable while printing.

12. The method of printing according to claim 11, wherein the conveyor includes a plurality of pulleys, the substrate is a web linked to the plurality of pulleys to transport the web while printing, and one of the plurality of pulleys includes the fibrillar adhesive system to stabilize the web while printing.

13. The method of printing according to claim 11, wherein the conveyor includes a conveyor belt wrapped around an inlet pulley and an outlet pulley; and
the step of connecting the substrate to the conveyor includes connecting the substrate to a top layer of the conveyor belt with the fibrillar adhesive system, which is disposed on the top layer of the conveyor belt.

14. The method of printing according to claim 13, further comprising the step of:
disconnecting the substrate from the top layer when the conveyor belt rotates around the outlet pulley.

15. The method of printing according to claim 11, wherein the fibrillar adhesive system includes an emulation of adhesive systems of toes of a beetle, a fly, or a spider.

16. The method of printing according to claim 11, wherein the fibrillar adhesive system includes synthetic setae which are emulations of setae on toes of a gecko.

17. An inkjet printer comprising:
a conveyor belt wrapped around an inlet pulley and an outlet pulley; wherein
a top layer of the conveyor belt includes a fibrillar adhesive system that connects to a substrate while printing.

18. The inkjet printer according to claim 17, wherein the fibrillar adhesive system is an emulation of adhesive systems of toes of a beetle, a fly, or a spider.

19. The inkjet printer according to claim 17, wherein the fibrillar adhesive system includes synthetic setae.

20. The inkjet printer according to claim 19, wherein the synthetic setae includes a first set of synthetic setae grouped in a first attaching zone on the top layer of the conveyor belt.

21. The inkjet printer according to claim 20, wherein a density of the synthetic setae is between 100 and 2000 synthetic setae per square millimeter.

22. The inkjet printer according to claim 17, wherein the conveyor belt includes synthetic setae at a bottom layer of the conveyor belt to support a conveying path of the conveyor belt while rotating around one of the inlet pulley and the outlet pulley.

23. The inkjet printer according to claim 17, wherein the substrate includes a flexible woven material.

24. The inkjet printer according to claim 17, wherein the inkjet printer is a roll-to-roll printer, and the substrate is a web.

25. The inkjet printer according to claim 17, wherein the conveyor belt includes a transfer belt that transfers ink layers onto the substrate.
